(19) United States
(12) Patent Application Publication
(10) Pub. No.: US 2022/0076939 A1
(43) Pub. Date: Mar. 10, 2022

(54) VACUUM ULTRAVIOLET EXCIMER LAMP WITH AN INNER AXIALLY SYMMETRIC WIRE ELECTRODE

(71) Applicant: Xylem Europe GmbH, Schaffhausen (CH)

(72) Inventors: Manfred Salvermoser, Herford (DE); Nicole Brüggemann, Lage (DE); Reiner Fietzek, Herford (DE); Ralf Fiekens, Schloß Holte-Stukenbrock (DE); Uwe Kanigowski, Velbert (DE); Andre Wojciechowski, Essen (DE)

(73) Assignee: Xylem Europe GmbH, Schaffhausen (CH)

(21) Appl. No.: 17/291,166

(22) PCT Filed: Nov. 5, 2019
(86) PCT No.: PCT/EP2019/080271

§ 371 Date: May 4, 2021

(30) Foreign Application Priority Data
Nov. 5, 2018 (EP) 18204301.8

(51) Int. Cl. H01J 61/06; H01J 61/32; H01J 61/16; H01J 61/30; H01J 61/44; H05B 41/30

(52) U.S. Cl. CPC H01J 61/06; H01J 61/32; H05B 41/30; H01J 61/302; H01J 61/44; H01J 61/16

(57) ABSTRACT

A dielectric barrier VUV excimer lamp has an elongated dielectric tube for holding an excimer-forming gas, a first electrode disposed within the dielectric tube, and a second electrode arranged outside of the dielectric tube. The first electrode is a wire electrode disposed along a centre axis of the dielectric tube, axially symmetric with respect to the centre axis, and physically connected to each end of the dielectric tube. The dielectric barrier VUV excimer lamp is an AC dielectric barrier discharge VUV excimer lamp or the dielectric barrier VUV excimer lamp is a pulsed DC dielectric barrier discharge VUV excimer lamp. A photochemical system has the dielectric barrier VUV excimer lamp. An excimer lamp system has the dielectric barrier VUV excimer lamp, and also has a power supply to supply electric power to the first electrode and the second electrode.

### CROSS-REFERENCE TO RELATED APPLICATIONS

This patent application is a U.S. National Phase Patent Application of PCT Application No. PCT/EP2019/080271, filed Nov. 5, 2019, which claims priority to European Patent Application No. EP18204301.8, filed Nov. 5, 2018, each of which is incorporated by reference herein in its entirety.

### FIELD OF THE INVENTION

The present invention relates to a dielectric barrier discharge VUV excimer lamp, to a photochemical ozone generator and to an excimer lamp system comprising such a dielectric barrier VUV excimer lamp.

### BACKGROUND OF THE INVENTION

Excimer lamps are used for generating high-energy ultraviolet (VUV) radiation. The excimer emission is generted by means of silent electrical discharge in a discharge chamber filled with an excimer-forming gas. The discharge chamber has walls formed from a material transparent to ultraviolet (UV) light. A first electrode is disposed within the chamber. A second electrode is arranged outside of the chamber. Due to the electric field generated between the electrodes a discharge occurs, generating excimer molecules. When these excited molecules return to ground state, high-energy ultraviolet light is emitted.

Known excimer lamps have low wall plug efficiencies and a short lifetime. Further, arcing can occur if a certain power density is exceeded.

Accordingly, it is an objective of the present invention to provide an efficient VUV excimer lamp with an extended lifespan.

### SUMMARY OF THE INVENTION

This problem is solved by a dielectric barrier discharge VUV excimer lamp. A photochemical ozone generator system is realized using such an excimer lamp.

In the following Vacuum Ultra-Violet (VUV) radiation is used to describe the UV spectrum below 190 nm. Ultraviolet C (UV-C) is generally referred to a short wavelength (100-280 nm) radiation, which is primarily used for disinfection, inactivating microorganisms by destroying nucleic acids and disrupting their DNA, leaving them unable to perform vital cellular functions.

According to the invention, a dielectric barrier discharge VUV excimer lamp comprising an elgonated dielectric tube for holding an excimer-forming gas, a first electrode disposed within said tube, a second electrode arranged outside of said tube, is provided, wherein said first electrode is a wire electrode disposed along a centre axis of the dielectric tube, axially symmetric (with assembly- and production-related inaccuracies) with respect to the centre axis and physically connected to each end of the dielectric tube. Said elongated thin wire is substantially (with assembly- and production-related inaccuracies) straight and defines a straight axis of elongation. It was found that the efficiency of the lamp greatly improved with such a wire electrode. The wire is preferably a flexible strand of metal in contrast to a stiff rod.

Preferably the lamp is an AC dielectric barrier discharge VUV excimer lamp or a pulsed DC dielectric barrier discharge VUV excimer lamp. The DC has preferably a pulse width <10 μs and/or pulse distance >1 μs but <100 s.

Preferably, The dielectric tube has an elongated wall with cylindrical shape and it extends linearly along the axial direction of the lamp body.

It is even more preferred that said elongated thin wire has an outer diameter between 0.02 mm and 0.4 mm. Preferably, the inner electrode has a thickness according to the following equation: (R/ro)/In(R/ro)>10, wherein 2*R is the inner diameter of the glass tube and 2*ro the outer diameter of the inner electrode. More preferably, the inner electrode has a thickness according to the following equation: (R/ro)/In(R/ro)>10. Due to the exponential behaviour of the electron multiplication within the gas even a difference of one with respect to prior art is considerable.

In an advantageous embodiment the gas filling pressure is in a range between 300 mbar and 50 bar. In one embodiment the gas filling pressure is about 340 mbar for a dielectric tube with an outer diameter of about 16 mm.

Preferably, said gas consists essentially of Xe.

In order to reach high efficiency, said gas should contain less than about 10 ppm of impurities.

Preferably, said dielectric tube is made of quartz glass, which is transparent to VUV radiation.

In a preferred embodiment said elongated thin wire is tensioned and centered with a spring arranged on one side of the elongated thin wire. This allows to avoid shadow over the length of the lamp compared to an inner electrode helically wound over the full length around a rod and to ensure tensioning of the electrode at high temperature, which allows to keep the coaxial symmetry. The inner electrode is preferably physically connected to each end of the dielectric tube.

Further, a photochemical ozone generator with a previous described dielectric barrier discharge VUV excimer lamp is provided.

For another application said dielectric tube of the dielectric barrier discharge VUV excimer lamp can have a UV-C fluorescent coating on the in- or outside with luminescent compounds, preferably phosphor. Said coating allows generation of UV-C radiation. A coating on the outside is beneficial, because it allows less stable and easier coating. If the coating is on the inside expensive glasses transparent to VUV radiation are not required, which reduces cost.

Finally, an excimer lamp system with a dielectric barrier discharge VUV excimer lamp described above and a power supply for supplying electric power to the first electrode and second electrode is provided.

### BRIEF DESCRIPTION OF THE DRAWINGS

Preferred embodiments of the present invention will be described with reference to the drawings. In all figures the same reference signs denote the same components or functionally similar components.

FIG. 1 shows a state of the art schematic illustration of an inner electrode of a VUV excimer lamp arranged inside a dielectric and an inner electrode design according to the present invention,

FIG. 2 shows a schematic illustration of the inner electrode according to the present invention,

FIG. 3 is a graph showing an efficiency comparison between the state of the art inner electrode and the inventive electrode,

FIG. 4 shows an emission spectrum of xenon in a barrier discharge depending on the Xenon gas pressure,

FIG. 5 shows a principle arrangement of an excimer lamp with a phosphor coating on the inside of the dielectric, and

FIG. 6 shows a principle arrangement of an excimer lamp with a phosphor coating on the outside of the dielectric.

### DETAILED DESCRIPTION OF THE INVENTION

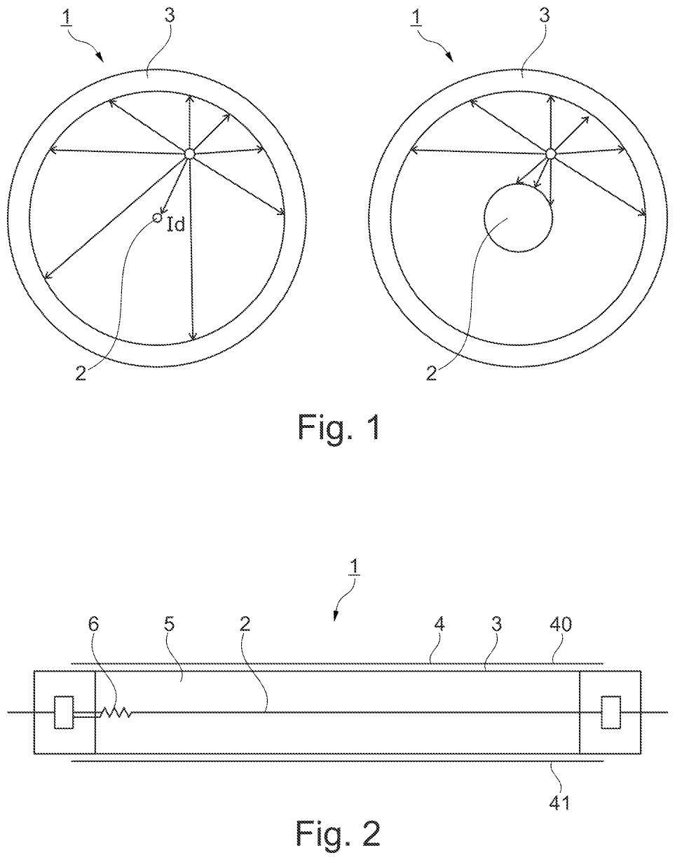

FIG. 1 shows on the right a state of the art inner electrode 2 of a VUV excimer lamp 1 within a discharge chamber formed by a dielectric 3. The inner electrode 2 is a high voltage electrode. According to the invention the inner electrode 2 is a thin wire (see FIG. 1, left) made out of a material with a high melting point, e.g. tungsten or molybdenum. The outer diameter of the inner electrode 2 d is equal or less than 0.5 mm. The wire 2 is clamped at both ends and tensioned, so that it is arranged in a straight line. Preferably, the wire is crimped tightly on both sides. By using such an electrode 2 in conjunction with a dielectric barrier, the discharge can be homogenized, which contributes to a significant efficiency improvement. In addition, the thin wire electrode 2 shields and absorbs the VUV radiation to a much lower proportion than conventional wider electrodes, which leads to efficiency improvement. This is shown by the arrows indicating the generated VUV radiation. Preferably, said elongated thin wire is substantially straight and defines a straight axis of elongation. In other words, the tube has an elongated wall with cylindrical shape and it extends linearly along the axial direction of the lamp body. The wire has a circular cross section. It is even more preferred that said elongated thin wire has an outer diameter between 0.02 mm and 0.4 mm. Preferably, the inner electrode has a thickness according to the following equation: (R/ro)/In(R/ro)>10, wherein 2*R is the inner diameter of the dielectric tube 3 and 2*ro the outer diameter of the inner electrode 2.

FIG. 2 shows a side view of an excimer lamp 1 including a dielectric tube 3, a first electrode (inner electrode) 2, and a second electrode (outer electrode) 4. The first and second electrodes 2 and 4 are connected to a driving circuit (not shown). The dielectric tube 3 is made of a dielectric, which is transparent for UV radiation, for instance quartz glass. The space within the dielectric tube, between the high voltage electrode and the dielectric is filled with high purity Xenon gas 5. The water content is smaller than 10 ppm for performance reasons.

The thin high voltage electrode wire 2 is tensioned and centered by means of a spring 6, attached to one end portion of the excimer lamp and to one end of the wire. The spring 6 is preferably made of an austenitic nickel-chromium-based superalloys, like Inconel. Ceramic is also applicable. The spring 6 must withstand temperatures up to 500° C. due to the baking process during lamp filling.

The dielectric 3 is surrounded by the second electrode 4 (ground electrode). This ground electrode 4 can be formed in different ways. The second electrode 4 is made of a conductive material. For instance, to form the second electrode 4, a tape or a conductive wire made of a metal (e.g., aluminum, copper) may be used. The second electrode 4 is in contact with the outer surface of the dielectric tube 3. The second electrode 4 includes linear electrodes 40, 41. The linear electrodes 40,41 are arranged substantially in parallel with each other and they extend along the longitudinal axis of the dielectric tube. In another embodiment the electrodes 4 can be formed in a spiral form on the outer surface of the dielectric tube 3. This configuration allows discharge to be generated uniformly in a circumferential direction of the dielectric tube 3, making it possible to obtain emission with more uniform distribution of brightness. Further, it is possible that the ground electrode 4 is a mesh or formed by water, which can act with minimal conductivity as electrode with a vessel being grounded.

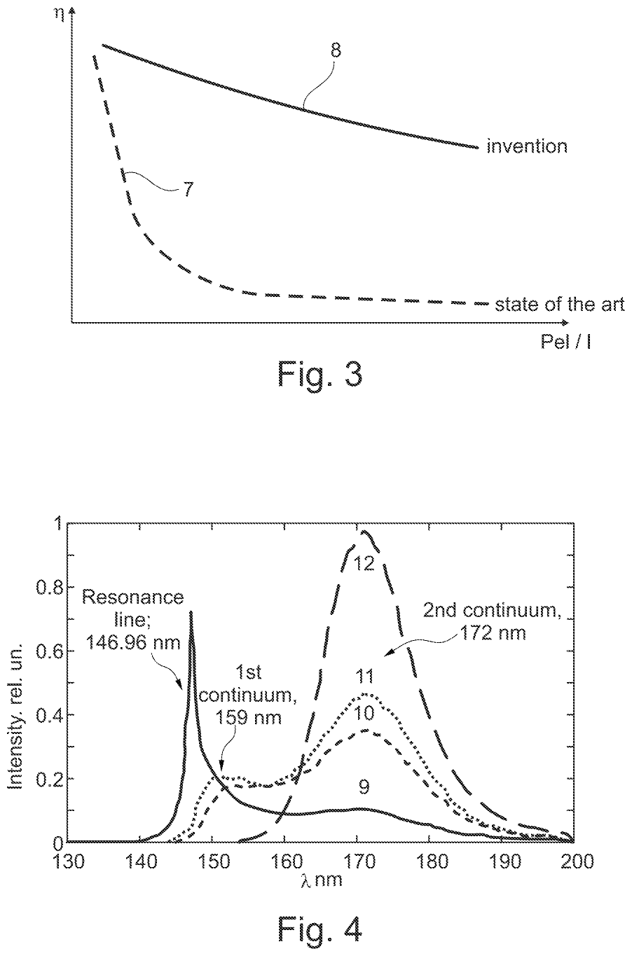

FIG. 3 shows a comparison of the lamp efficiency between a state of the art excimer lamp 1 according to FIG. 1 (right) 7 and an excimer lamp 1 with an inner electrode 2 according to the present invention (according to FIG. 1 left). Surprisingly, the efficiency of the excimer lamp according to the invention 7 drops only slowly almost in a linear fashion while state of the art excimer lamps rapidly loose efficiency with increasing power input 8.

The lifetime of the lamps can be improved by increasing the gas filling pressure. FIG. 4 shows the emission spectrum of Xenon in a barrier discharge depending on the Xenon gas pressure. The measured pressures 49 mbar, 69 mbar, 100 mbar and 680 mbar are represented in the diagram with lines 9,10,11,12. The resonance line at 147 nm dominates at low pressures (49 mbar) 9. With increasing pressure the desired 172 nm output intensifies, while short wavelength components decrease. Below 160 nm an impact of the quartz sleeve can be seen. Efficiency of the 172 nm VUV radiation as well as the lamp lifetime improves at higher Xenon pressures.

In particular quartz tubes with an outer diameter of 16 mm and a length of 50 cm were tested. For this lamp configuration, the pressure of the gas filling should be around p_{XE}=300 mbar, preferably between 280 mbar and 370 mbar, more preferably between 300 mbar and 350 mbar. The best results for this configuration were achieved with p_{XE}=340 mbar. For other quartz tube diameters other pressures are optimal.

The emitted VUV light has a wavelength of 172 nm, which is ideal for the production of ozone. In comparison to conventional ozone generation process with the silent discharge oxygen molecules are split by photons instead of electrons. As a result, no nitrogen oxides are produced and clean Ozone in purest Oxygen feed gas can be generated. Moreover extremely high ozone concentrations can be achieved. Further, it is advantageous that there is no upper limit to the feed gas pressure used in such a photochemical ozone generator.

Another application of the VUV excimer lamp is the generation of UV-C radiation. In this case the dielectric has to be coated with a UV-C fluorescent material, e.g. a layer of phosphorus compounds like YP04: Bi. These compounds absorb the 172 nm radiation and reemit light in the UV-C range (Stokes shift). The wavelength of the emitted radiation depends on the composition of the phosphorus layer. It can be adapted to the application.

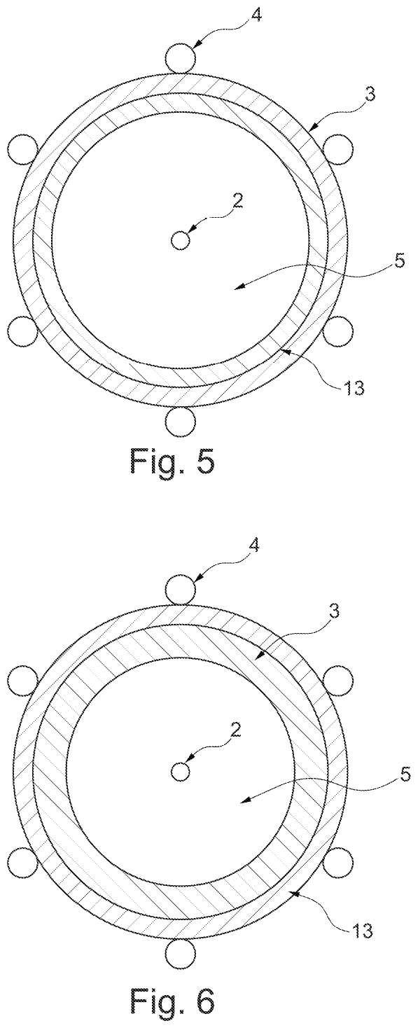

As shown in FIG. 5 the UV-C fluorescent coat 13 can be formed on an inner surface of the dielectric tube 3. Upon application of a voltage across the first and second electrodes 2 and 4 by a driving circuit, glow discharge occurs inside the dielectric tube 3, which excites the discharge medium xenon 5. When the excited discharge medium 5 makes a transition to a ground state, the discharge medium emits ultraviolet light. The ultraviolet light excites a phosphor of the phosphor layer 13, and the excited phosphor emits light in the UV-C range.

The second electrode 4 includes a plurality of linear or spiral wound electrodes arranged substantially in parallel with each other, they can be formed as a wire or strip, so that only a small section is affected by the discharge. A protecting layer of Al₂O₃ or MgO can be arranged on the inside of the UV-C fluorescent coat 13 for protecting the coat 13 from the discharge plasma. Optimizing Xenon pressure as discussed above also leads to extended durability of the phosphor coating 13.

FIG. 6 shows another embodiment with a UV-C fluorescent coat 13 arranged on the outer surface of the dielectric tube 3, between the dielectric 3 and the second electrode 4. The advantage of such an external coating is that the phosphor layer 13 has no contact with the plasma and can't be destroyed by the discharge. However, a special dielectric sleeve 3 is necessary which is able to resist as well as transmit the VUV radiation to the phosphor. Applicable is for example synthetic quartz e.g. Suprasil 310. Upon application of a voltage across the first and second electrodes 2 and 4 by a driving circuit, glow discharge occurs inside the dielectric tube 3, which excites the discharge medium xenon 5. When the excited discharge medium 5 makes a transition to a ground state, the discharge medium emits ultraviolet light. The ultraviolet light excites a phosphor of the phosphor layer 13, and the excited phosphor emits light in the UV-C range.

With phosphor coatings an efficient mercury-free UV-C lamp can be reached, which has no warm-up time, is fully dimmable (0 to 100% without loss in efficiency) while tolerating a wide range of operational temperature.

1-17. (canceled)

18. A dielectric barrier discharge VUV excimer lamp comprising:
an elongated dielectric tube having a center axis;
an excimer-forming gas contained within the dielectric tube;
a first wire electrode disposed within the dielectric tube along the center axis, the first wire axially symmetric with respect to the center axis and physically connected to each end of the dielectric tube; and
a second electrode arranged outside of the dielectric tube.

19. The lamp of claim 18, wherein the lamp comprises an AC dielectric barrier discharge VUV excimer lamp.

20. The lamp of claim 18, wherein the lamp comprises a pulsed DC dielectric barrier discharge VUV excimer lamp having a pulsating direct current.

21. The lamp of claim 20, wherein the pulsating direct current has:
(a) a pulse width of less than 10 μs,
(b) a pulse distance of greater than 1ps and less than 100 s, or
(c) a combination of (a) and (b).

22. The lamp of claim 18, wherein the first electrode has an outer diameter between 0.02 mm and 0.4 mm.

23. The lamp of claim 18, wherein:
the first electrode has a thickness according to the following equation:
(R/ro)/In(R/ro)>8, where
2*R is the inner diameter of the dielectric tube, and
2*ro the outer diameter of the first electrode.

24. The lamp of claim 23, wherein the first electrode has a thickness according to the following equation: (R/ro)/In(R/ro)>10.

25. The lamp of claim 18, wherein the dielectric tube has an elongated wall with cylindrical shape.

26. The lamp of claim 18, wherein a gas filling pressure of the dielectric tube is in a range between 300 mbar and 50 bar.

27. The lamp of claim 26, wherein:
the gas filling pressure is 340 mbar; and
the dielectric tube has an outer diameter of 16 mm.

28. The lamp of claim 18, wherein the excimer-forming gas comprises Xe.

29. The lamp of claim 28, wherein the excimer-forming gas consists essentially of Xe.

30. The lamp of claim 18, wherein the excimer-forming gas contains less than about 10 ppm of impurities.

31. The lamp of claim 18, wherein the dielectric tube comprises quartz glass.

32. The lamp of claim 18, wherein:
the first electrode is tensioned and centered; and
at least one spring is arranged on one at least one side of the first electrode.

33. The lamp of claim 18, wherein the dielectric tube comprises a fluorescent coating including luminescent compounds on an inside or an outside of the dielectric tube.

34. The lamp of claim 18, wherein the dielectric tube comprises a UV fluorescent coating including luminescent compounds on an inside or an outside of the dielectric tube.

35. The lamp of claim 34, wherein the dielectric tube comprises a UV-C fluorescent coating including luminescent compounds on the inside or the outside of the dielectric tube.

36. The lamp of claim 35, wherein the UV-C fluorescent coating comprises phosphorus compounds.

37. A photochemical ozone generator comprising the dielectric barrier discharge VUV excimer lamp of claim 18.

38. An excimer lamp system comprising:
the dielectric barrier discharge VUV excimer lamp of claim 18; and
a power supply configured to supply electric power to the first electrode and the second electrode.
